(19) United States
(12) Patent Application Publication
(10) Pub. No.: US 2009/0176946 A1
(43) Pub. Date: Jul. 9, 2009

(54) POLYCARBONATE BLENDS WITH HIGH SCRATCH RESISTANCE AND DUCTILITY

(75) Inventors: Adrianus Alphonsus Maria Kusters, Chaam (NL); Jan Pleun Lens, Breda (NL); Andries Jakobus Petrus van Zyl, Roosendaal (NL)

Correspondence Address: SABIC - LEXAN;SABIC Innovative Plastics - IP Legal, ONE PLASTICS AVE., PITTSFIELD, MA, 01201-3697, US

(73) Assignee: SABIC Innovative Plastics IP B.V., Bergen op Zoom (NL)

(21) Appl. No.: 11/968,841

(22) Filed: Jan. 3, 2008

(51) Int. Cl. C08L 69/00

(52) U.S. Cl. 525/462

(57) ABSTRACT

A blend of a first polycarbonate polymer comprising at least about 85% dimethyl bisphenol cyclohexane (DMBPC) units with a second polycarbonate polymer is disclosed. The blend has a combination of high scratch resistance and good ductility.

### BACKGROUND

The present disclosure relates to certain polycarbonate blends having a combination of high scratch resistance and ductility. Also disclosed herein are methods for preparing and/or using the same.

Polycarbonates are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution.

Polycarbonates are a very useful class of polymers. They have many properties and/or characteristics that are desired in certain instances. Furthermore, polycarbonates can be readily used in various article formation processes, such as molding (injection molding, etc.), extrusion, and thermoforming, among others. As a result, polycarbonates are used frequently to form a wide variety of molded products such as medical devices, radio and TV bezels (i.e. grooved rims for holding glass or plastic panes such as lenses, tuning dials, and other indicating devices), mobile phone keypads, notebook computer housings and keys, optical display films, automotive parts, and other electronic and consumer products.

In particular, polycarbonates based on bisphenol-A (BPA) have limited scratch resistance. The introduction of scratches causes loss of optical properties, such as transparency in clear compositions and haze or gloss in opaque compositions. Scratches also decrease the aesthetic appeal of a product.

One method of preventing or minimizing scratch damage is to apply a hardcoat to an article formed from a BPA polycarbonate. This hardcoat requires another manufacturing step, adding additional cost to the article.

Another method is to use a scratch-resistant material made from a copolymer of BPA and dimethyl bisphenol cyclohexane (DMBPC). These copolymers have excellent scratch resistance, but decreased impact properties and ductility compared to BPA homopolymers. DMBPC homopolymers have a 6-fold increase in scratch resistance compared to polycarbonates based on BPA and up to a 2-fold increase compared to a BPA-DMBPC copolymer, based on the pencil hardness scale. However, DMBPC homopolymers also have decreased impact properties and ductility compared to polycarbonates based on BPA.

It would be desirable to provide a polycarbonate composition that has a combination of high scratch resistance and good ductility.

### BRIEF DESCRIPTION

Disclosed, in various embodiments, are polycarbonate blends and processes for making and using them. The polycarbonate blends have a combination of good scratch resistance and ductility.

In embodiments, a polycarbonate blend comprises:
a first polycarbonate polymer comprising at least about 85% dimethyl bisphenol cyclohexane (DMBPC) units of Formula (I):

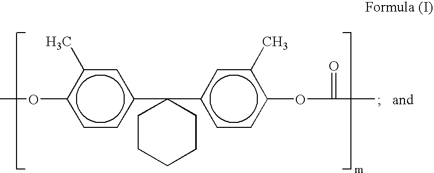

a second polycarbonate polymer which differs from the first polycarbonate polymer;
wherein a molded sample of the polycarbonate blend has a scratch rating of F or harder according to ASTM D3363-92a and an impact value of at least 50 Joules according to ISO 6603.

The first polycarbonate polymer may have a melt volume flow rate of from about 4 to about 25 cm³/10 minutes. The second polycarbonate polymer may have a melt volume flow rate of from about 5 to about 30 cm³/10 minutes.

The first polycarbonate polymer may have a weight average molecular weight of from about 20,000 to about 30,000 g/mol. The second polycarbonate polymer may have a weight average molecular weight of from about 20,000 to about 30,000 g/mol. The molecular weights are measured by gel permeation chromatography and expressed relative to bisphenol-A polycarbonate standards.

The weight ratio of the second polycarbonate polymer to first polycarbonate polymer may be from about 10:90 to about 90:10, or from about 40:60 to about 60:40.

In some embodiments, the second polycarbonate polymer comprises a monomer of Formula (II):

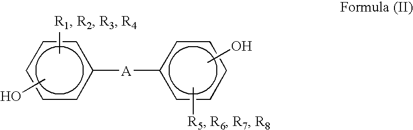

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In other embodiments, the second polycarbonate polymer may consist of repeating units of Formula (III):

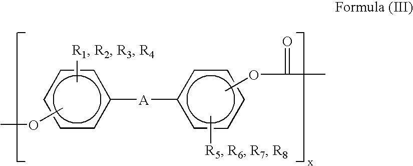

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In other embodiments, the second polycarbonate polymer comprises a bisphenol-A homopolymer.

The polycarbonate blend may also have an impact value of at least 100 Joules according to ISO 6603.

In other embodiments, a polycarbonate blend comprises:
a dimethyl bisphenol cyclohexane (DMBPC) homopolymer having repeating units of Formula (I):

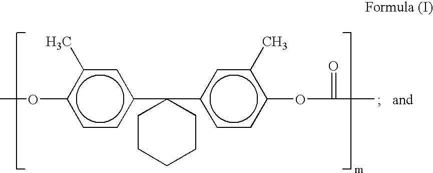

a bisphenol-A homopolymer;
wherein a molded sample of the polycarbonate blend has a scratch rating of F or harder according to ASTM D3363-92a and an impact value of at least 100 Joules according to ISO 6603.

In other embodiments, an article is molded from a polycarbonate blend comprising:
a first polycarbonate polymer including at least about 85% of dimethyl bisphenol cyclohexane (DMBPC) units of Formula (I):

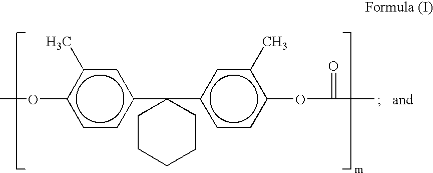

a second polycarbonate polymer which differs from the first polycarbonate polymer;
wherein a molded sample of the polycarbonate blend has a scratch rating of F or harder according to ASTM D3363-92a and an impact value of at least 50 Joules according to ISO 6603.

The article may be selected from the group consisting of a bezel, a keypad, a housing, and an optical display film.

These and other non-limiting characteristics are more particularly described below.

### DETAILED DESCRIPTION

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

The polycarbonate blend of the present disclosure comprises a first polycarbonate polymer comprising dimethyl bisphenol cyclohexane (DMBPC) units and a second polycarbonate polymer which differs from the first polycarbonate polymer. The polycarbonate blend has a scratch rating of F or harder according to ASTM D3363-92a and an impact value of at least 50 Joules according to ISO 6603.

The first polycarbonate polymer contains DMBPC units. DMBPC is also known as 1,1-bis(4-hydroxy-3-methylphenyl)cyclohexane and has the structure shown below:

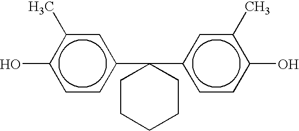

The first polycarbonate polymer comprises at least about 85% of units of Formula (I):

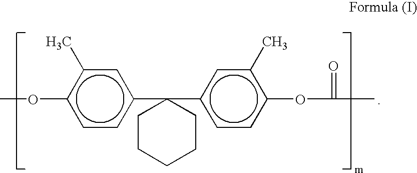

This percentage is equivalent to mole percent. In other words, at least about 85% of all units in the first polycarbonate polymer are DMBPC units. In embodiments where the first polycarbonate polymer is a DMBPC homopolymer, m is the degree of polymerization. In embodiments, the first polycarbonate polymer has a weight average molecular weight of from about 20,000 to about 30,000. In other embodiments, the first polycarbonate polymer has a melt volume flow rate of from about 4 to about 25 cm³/10 minutes.

The second polycarbonate polymer may be a repeating structural carbonate unit of the formula (1):

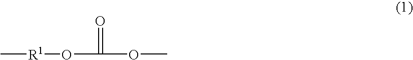

in which at least 60 percent of the total number of R¹ groups are aromatic organic radicals and the balance thereof are aliphatic, alicyclic, or aromatic radicals, but is different from the first polycarbonate polymer. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above. Also included are bisphenol compounds of general formula (4):

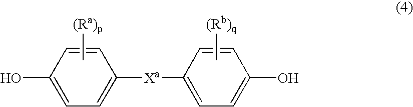

wherein R^{a} and R^{b} each represent a halogen atom or a monovalent hydrocarbon group and may be the same or different; p and q are each independently integers of 0 to 4; and X^{a} represents one of the groups of formula (5):

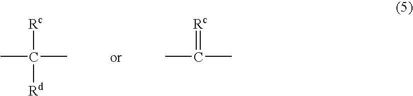

wherein R^{c} and R^{d} each independently represent a hydrogen atom or a monovalent linear or cyclic hydrocarbon group and R^{e} is a divalent hydrocarbon group.

In an embodiment, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)-, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group may have 3 to 20 atoms, and may be a single saturated or unsaturated ring, or fused polycyclic ring system wherein the fused rings are saturated, unsaturated, or aromatic.

Other bisphenols containing substituted or unsubstituted cyclohexane units can be used, for example bisphenols of formula (6):

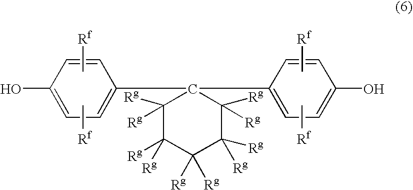

wherein each R^{f} is independently hydrogen, C₁₋₁₂ alkyl, or halogen; and each R⁹ is independently hydrogen or C₁₋₁₂ alkyl. The substituents may be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

Other useful dihydroxy compounds having the formula HO—R¹—OH include aromatic dihydroxy compounds of formula (7):

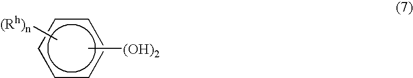

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

The second polycarbonate polymer may be selected from homopolycarbonates, copolymers comprising different R¹ moieties in the carbonate (referred to herein as “copolycarbonates”), and copolymers comprising carbonate units and other types of polymer units, such as ester units or polysiloxane units.

A specific type of copolymer is a polyester-polycarbonate. Such copolymers further contain, in addition to recurring carbonate chain units of the formula (1), repeating units of formula (8):

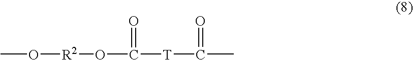

wherein R² is a divalent group derived from a dihydroxy compound, and may be, for example, a C₂₋₁₀ alkylene group, a C₆₋₂₀ alicyclic group, a C₆₋₂ aromatic group or a polyoxyalkylene group in which the alkylene groups contain 2 to about 6 carbon atoms, specifically 2, 3, or 4 carbon atoms; and T divalent group derived from a dicarboxylic acid, and may be, for example, a C₂₋₁₀ alkylene group, a C₆₋₂ alicyclic group, a C₆₋₂₀ alkyl aromatic group, or a C₆₋₂₀ aromatic group.

In an embodiment, R² is a C₂₋₃ alkylene group having a straight chain, branched chain, or cyclic (including polycyclic) structure. In another embodiment, R² is derived from an aromatic dihydroxy compound of formula (4) above. In another embodiment, R² is derived from an aromatic dihydroxy compound of formula (7) above.

Examples of aromatic dicarboxylic acids that may be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is about 91:9 to about 2:98. In another specific embodiment, R² is a C₂₋₆ alkylene group and T is p-phenylene, m-phenylene, naphthalene, a divalent cycloaliphatic group, or a combination thereof. This class of polyester includes the poly(alkylene terephthalates).

Useful polyesters may include aromatic polyesters, poly(alkylene esters) including poly(alkylene arylates), and poly(cycloalkylene diesters). Aromatic polyesters may have a polyester structure according to formula (8), wherein D and T are each aromatic groups as described hereinabove. In an embodiment, useful aromatic polyesters may include, for example, poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)]ester, or a combination comprising at least one of these. Also contemplated are aromatic polyesters with a minor amount, e.g., about 0.5% by weight to about 10% by weight, based on the total weight of the polyester, of units derived from an aliphatic diacid and/or an aliphatic polyol to make copolyesters. Poly(alkylene arylates) may have a polyester structure according to formula (8), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters may also be used.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexane-dimethanol-1,4-cyclohexanedicarboxylate) (PCCD), having recurring units of formula (9):

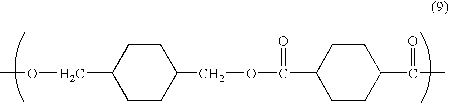

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

The second polycarbonate polymer may also be a polysiloxane-polycarbonate copolymer. The polysiloxane (also referred to herein as “polydiorganosiloxane”) blocks of the copolymer comprise repeating siloxane units (also referred to herein as “diorganosiloxane units”) of formula (10):

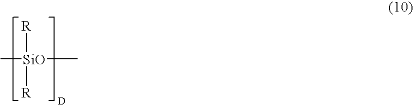

wherein each occurrence of R is same or different, and is a C₁₋₁₃ monovalent organic radical. For example, R may independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups may be fully or partially halogenated with fluorine, chlorine, bromine, or iodine, or a combination thereof. Combinations of the foregoing R groups may be used in the same copolymer.

The value of D in formula (10) may vary widely depending on the type and relative amount of each component in the polymer, the desired properties of the polymer, and like considerations. Generally, D may have an average value of 2 to 1,000, specifically 2 to 500, and more specifically 5 to 100. In one embodiment, D has an average value of 10 to 75, and in still another embodiment, D has an average value of 40 to 60.

A combination of a first and a second (or more) polysiloxane-polycarbonate copolymer may be used, wherein the average value of D of the first copolymer is less than the average value of D of the second copolymer.

In one embodiment, the polydiorganosiloxane blocks are provided by repeating structural units of formula (11):

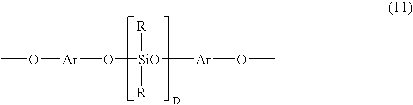

wherein D is as defined above; each R may independently be the same or different, and is as defined above; and each Ar may independently be the same or different, and is a substituted or unsubstituted C₆-C₃₀ arylene radical, wherein the bonds are directly connected to an aromatic moiety. Useful Ar groups in formula (11) may be derived from a C₆-C₃₀ dihydroxyarylene compound, for example a dihydroxyaryiene compound of formula (3), (4), or (7) above. Combinations comprising at least one of the foregoing dihydroxyarylene compounds may also be used. Specific examples of dihydroxyarylene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds may also be used.

Units of formula (11) may be derived from the corresponding dihydroxy compound of formula (12):

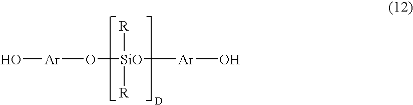

wherein R, Ar, and D are as described above. Compounds of formula (12) may be obtained by the reaction of a dihydroxyarylene compound with, for example, an alpha, omega-bisacetoxypolydiorganosiloxane under phase transfer conditions.

In another embodiment, polydiorganosiloxane blocks comprise units of formula (13):

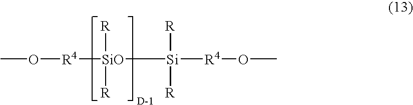

wherein R and D are as described above, and each occurrence of R⁴ is independently a divalent C₁-C₃₀ alkylene, and wherein the polymerized polysiloxane unit is the reaction residue of its corresponding dihydroxy compound. In a specific embodiment, the polydiorganosiloxane blocks are provided by repeating structural units of formula (14):

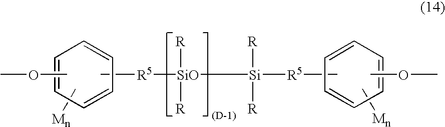

wherein R and D are as defined above. Each R⁵ in formula (14) is independently a divalent C₂-C₈ aliphatic group. Each M in formula (14) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R⁵ is a divalent C₁-C₃ aliphatic group, and R is methyl.

Units of formula (14) may be derived from the corresponding dihydroxy polydiorganosiloxane (15):

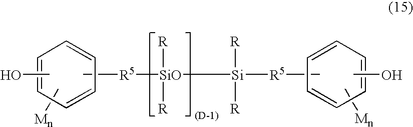

wherein R, D, M, R⁵, and n are as described above. Such dihydroxy polysiloxanes can be made by effecting a platinum catalyzed addition between a siloxane hydride of formula (16):

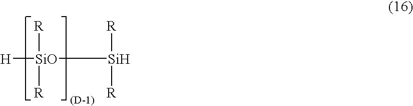

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

Polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. In an exemplary embodiment, an interfacial polymerization reaction to form carbonate linkages uses phosgene as a carbonate precursor, and is referred to as a phosgenation reaction.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1% by weight to about 10% by weight based on the weight of bisphenol in the phosgenation mixture. In another embodiment an effective amount of phase transfer catalyst may be about 0.5% by weight to about 2% by weight based on the weight of bisphenol in the phosgenation mixture.

Branched polycarbonate blocks may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05% by weight to about 2.0% by weight. Mixtures comprising linear polycarbonates and branched polycarbonates may be used.

The second polycarbonate polymer of the polycarbonate blend may be selected from any of the polycarbonate copolymers described above. In specific embodiments, the second polycarbonate polymer is a BPA homopolymer, a polyester-polycarbonate copolymer, or a polydimethylsiloxane-polycarbonate copolymer.

In specific embodiments, the second polycarbonate polymer comprises a monomer having the structure of Formula (II):

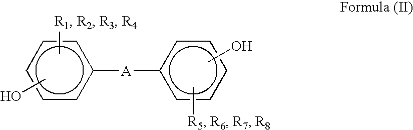

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

Some illustrative, non-limiting examples of suitable bisphenol compounds of Formula (II) include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxy-3 methyl phenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy aromatic compounds.

Specific examples of the types of bisphenol compounds represented by Formula (II) include 1,1-bis(4-hydroxyphenyl)methane, 1,1-bis(4-hydroxyphenyl)ethane, 2,2-bis(4-hydroxyphenyl)propane (hereinafter “bisphenol-A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PPPBP”), and 9,9-bis(4-hydroxyphenyl)fluorene. Combinations comprising at least one of the foregoing dihydroxy aromatic compounds can also be used.

In some embodiments, the second polycarbonate polymer has the structure of Formula (III):

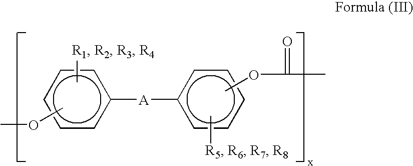

wherein R₁ through R₈ are each independently selected from hydrogen, halogen, nitro, cyano, C₁-C₂₀ alkyl, C₄-C₂₀ cycloalkyl, and C₆-C₂₀ aryl; A is selected from a bond, —O—, —S—, —SO₂—, C₁-C₁₂ alkyl, C₆-C₂₀ aromatic, and C₆-C₂₀ cycloaliphatic; and x is the degree of polymerization. In embodiments, the second polycarbonate polymer has a weight average molecular weight of from about 20,000 to about 30,000. In other embodiments, the second polycarbonate polymer has a melt volume flow rate of from about 5 to about 30 cm³/10 minutes

The polycarbonate blend may further comprise a mold release agent. The mold release agent is able to migrate to the surface during molding. Suitable materials may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like.

In specific embodiments, the mold release agent comprises a material from at least one of the following four groups: (1) an organic material containing at least one carboxylic group; (2) an organic material containing a backbone of siloxane chains; (3) a terminal or pendant saturated aliphatic hydrocarbon chain containing at least 4 carbon atoms; and (4) a linear or branched aliphatic chain containing at least 20 carbon atoms. Exemplary mold release agents falling within group (1) include alkyl stearyl esters such as pentaerythritol tetrastearate. Exemplary mold release agents falling within group (2) include polydimethylsiloxanes. Exemplary mold release agents falling within group (3) include fatty acids, such as stearic acid. Exemplary mold release agents falling within group (4) include polyalphaolefins.

In the polycarbonate blend, the weight ratio of the second polycarbonate polymer to the first polycarbonate polymer (or DMBPC homopolymer, in some embodiments) may be from about 10:90 to about 90:10. In more specific embodiments, the weight ratio of second polycarbonate polymer to first polycarbonate polymer is from about 40:60 to about 60:40. In yet other embodiments, the weight ratio of second polycarbonate polymer to first polycarbonate polymer is from about 10:90 to about 60:40. The polycarbonate blend, when molded, has a scratch rating of at least F (or harder) according to ASTM D3363-92a and an impact value of at least 50 Joules according to ISO 6603. Generally, in the pencil hardness test of ASTM D3363-92a, a load of 1 kgf is applied to a disk at room temperature using a set of pencils having known hardnesses. A scratch rating is given based on the visibility of a scratch on a set of 5 specimens. The scratch ratings are 6B (softest), 5B, 4B, 3B, 2B, B, HB, F, H, 2H, 3H, 4H, 5H, and 6H (hardest). The multiaxial impact value (MAI) measured according to ISO 6603 indicates the amount of energy the blend absorbs during the test; a higher value indicates a better result.

The first polycarbonate polymer can be blended together with the second polycarbonate polymer, using well-known methods, to form a polycarbonate blend. For example, they may be combined by mixing in solution or in melt in an extruder or other mixer.

The polycarbonate blend may further include other additives which can be incorporated with polymeric compositions, with the proviso that the additives are selected so as not to adversely affect the desired properties of the polycarbonate blend. Mixtures of additives may be used. Such additives may be mixed at a suitable time during the mixing of the components. Examples of such additives include fillers, antioxidants, heat stabilizers, light stabilizers, plasticizers, lubricants, antistatic agents, flame retardants, impact modifiers, and anti-drip agents.

The polycarbonate blends have a desirable combination of high scratch resistance and ductility which was unexpected. DMBPC homopolymers are generally brittle, not ductile. Copolymers of DMBPC and polycarbonates can be made that are ductile, but such copolymers generally experience severely decreased scratch resistance due to the decreased overall content of DMBPC. It would have been expected that a blend would have properties similar to a copolymer having the same overall DMBPC content. However, the properties of the polycarbonate blends of the present disclosure cannot be achieved by a copolymer of DMBPC and polycarbonate having the same overall content of DMBPC. For example, a blend of DMBPC homopolymer and polycarbonate is ductile, whereas the copolymer is brittle.

The polycarbonate blends of the present disclosure are suitable for use in molding articles. The shaped articles can be compression molded, injection molded, blow molded, injection-blow-molded, or extruded. The article can be a solid sheet, an extruded multi-wall sheet, a cast film, or an extruded film. The article can also be a multi-layered article where the outer layer is made from the polycarbonate blend. Such multi-layered articles include a co-extruded solid sheet, a co-extruded multi-wall sheet, a co-extruded film, or a film cast onto a separately molded part. Alternatively, the multi-layered article may be made by molding a different resin onto a film made from the polycarbonate blend. Examples of such applications include TV and notebook bezels. Multi-layer articles may be used in mobile phones and other consumer electronic products.

The following examples are provided to illustrate the compositions and methods of the present disclosure. The examples are merely illustrative and are not intended to limit devices made in accordance with the disclosure to the materials, conditions, or process parameters set forth therein.

### EXAMPLES

Various methods were used to characterize the scratch resistance of various polycarbonate blends of DMBPC-containing polymer with bisphenol-A (BPA) polycarbonate polymers.

Scratch testing was also measured by the Pencil hardness method, which was followed according to ASTM D3363-92a using a Pencil scratch hardness tester. A load of 1 kgf is applied to a molded disk at room temperature using specially manufactured Mitsubishi-UNI pencils. Pencils are carefully cut and polished with a 400-grit abrasive paper. A scratch rating is assigned corresponding to the hardest pencil that does not scratch the sample surface, or scratches the surface at most one out of five scratch attempts. Thus, an H pencil rating is assigned to a specific material if this material is scratched 0/5 or 1/5 times with a pencil of H hardness.

Multiaxial impact was measured on injection molded 3.2 mm impact disks using a Zwick HTM 2012. Impact values are reported as maximum energy to failure in Joules (J) and % ductility. The impact velocity was 4.40 m/s and measurements were done at 23° C. The ISO 6603 test protocol was followed. The impact value is a good proxy for ductility.

Gel Permeation Chromatography (GPC) was used to determine the molecular weights (Mw and Mn, and polydispersity) of the polycarbonates. A crosslinked styrene-divinylbenzene mixed-bed column was used for the analysis. The column temperature was maintained at 30° C. The column was eluted with chloroform as eluent, at a flow rate of 1.00 mL per minute. The sample solution was prepared by dissolving the 20 milligrams (mg) of the isosorbide polycarbonate in 10 mL of chloroform. 10 microliters (μL) of the sample solution was injected in the column and the sample was eluted over a total run time of less than 2 hours. A calibration curve (i.e., a universal calibration curve) was constructed using bisphenol A polycarbonate standards. Molecular weights were expressed as molecular weights against bisphenol-A polycarbonate. A refractive index detector was used.

The melt volume rate was determined according to ISO 1133 at 300° C., 1.2 kg load.

### Example 1

Two different DMBPC homopolymers and three different BPA resins were blended in various combinations. The properties of the blends were then compared to three comparative examples. Comparative Example 1 was a BPA-DMBPC (44:56 wt %) copolymer with MVR=12.5. Comparative Example 2 was a DMBPC homopolymer with MVR=16.5. Comparative Example 3 was a DMBPC homopolymer with MVR=8.1. The two DMBPC homopolymers used in the blends were identical to Comparative Examples 2 and 3. The properties of these resins are listed in Table 1 below.

TABLE 1

| | Melt Volume Rate | |
|---|---|---|
| Resin | (cm³/10 min) | Mw (g/mol) |
| DMBPC:BPA copolymer | 12.5 | 23,300 |
| DMBPC homopolycarbonate 1 | 16.5 | 21,000 |
| DMBPC homopolycarbonate 2 | 8.1 | 25,000 |
| BPA Resin 1 | 29.6 | 21,800 |
| BPA Resin 2 | 11.5 | 26,200 |
| BPA Resin 3 | 5.9 | 30,500 |

Nine example compositions were made, all of them using the DMBPC homopolymer with MVR=16.5 (DMBPC homopolycarbonate 1), and blended with a BPA resin in varying weight percentages. The compositions were then compared to Comparative Examples 1 and 2 in four properties: melt volume rate (MVR), multiaxial impact (MAI), % ductility, and pencil hardness. The compositions and results are shown in Table 2 below.

TABLE 2

| | | Final | Final | | | | |
|---|---|---|---|---|---|---|---|
| | BPA | BPA | DMBPC | MVR | MAI | % | Pencil |
| | Resin | wt % | wt % | (cm³/10 min) | (J) | Ductility | Hardness |
| DMBPC:BPA | — | 44 | 56 | 12.5 | 3 | 0 | H |
| copolymer | | | | | | | |
| DMBPC | — | 0 | 100 | 16.5 | 2 | 0 | 2H |
| homopolycarbonate 1 | | | | | | | |
| Example 1 | 1 | 17 | 83 | 18.4 | 2.9 | 0 | 2H |
| Example 2 | 1 | 34 | 66 | 20.3 | 2.7 | 0 | H |
| Example 3 | 1 | 50 | 50 | 21.3 | 71.1 | 60 | F |
| Example 4 | 2 | 17 | 83 | 16 | 2.3 | 0 | 2H |
| Example 5 | 2 | 34 | 66 | 14.5 | 3.5 | 0 | H |
| Example 6 | 2 | 50 | 50 | 13.9 | 109.6 | 80 | F |
| Example 7 | 3 | 17 | 83 | 12.8 | 2.5 | 0 | 2H |
| Example 8 | 3 | 34 | 66 | 10.2 | 3.4 | 0 | H |
| Example 9 | 3 | 50 | 50 | 8.6 | 126.9 | 100 | F |

The results show that at mixtures of 50:50 wt/wt, the MAI and % ductility of the blend increased dramatically and were much higher than a similar copolymer (DMBPC:BPA copolymer). The pencil hardness rating decreased as the amount of BPA in the blend increased, but a scratch rating of F is still acceptable.

### Example 2

Another nine example compositions were made, all of them using the DMBPC homopolymer with MVR=8.1 (DMBPC homopolycarbonate 2), and blended with a BPA resin in varying weight percentages. The compositions were then compared to Comparative Examples 1 and 3 in four properties: melt volume rate (MVR), multiaxial impact (MAI), % ductility, and pencil hardness. The compositions and results are shown in Table 3 below.

TABLE 3

| | | Final | Final | | | | |
|---|---|---|---|---|---|---|---|
| | BPA | BPA | DMBPC | MVR | MAI | % | Pencil |
| | Resin | wt % | wt % | (cm³/10 min) | (J) | Ductility | Hardness |
| DMBPC:BPA | — | 44 | 56 | 12.5 | 3 | 0 | H |
| copolymer | | | | | | | |
| DMBPC | — | 0 | 100 | 8.1 | 3.4 | 0 | 3H |
| homopolycarbonate 2 | | | | | | | |
| Example 10 | 1 | 17 | 83 | 10.1 | 3 | 0 | 2H |
| Example 11 | 1 | 34 | 66 | 12.5 | 2.7 | 0 | H |
| Example 12 | 1 | 50 | 50 | 15.7 | 51.9 | 40 | F |
| Example 13 | 2 | 17 | 83 | 8.8 | 3.1 | 0 | 2H |
| Example 14 | 2 | 34 | 66 | 9.6 | 2.8 | 0 | H |
| Example 15 | 2 | 50 | 50 | 10.2 | 100.8 | 80 | H |
| Example 16 | 3 | 17 | 83 | 7.2 | 5 | 0 | 2H |
| Example 17 | 3 | 34 | 66 | 6.6 | 3.6 | 0 | H |
| Example 18 | 3 | 50 | 50 | 6.2 | 119.2 | 80 | H |

Again, at mixtures of 50:50 wt/wt, the MAI and % ductility of the blend increased dramatically and were much higher than a similar copolymer (DMBPC:BPA copolymer). The pencil hardness rating decreased as the amount of BPA in the blend increased, but a scratch rating of F is still acceptable. Comparing Examples 1-9 with Examples 10-18, as the molecular weight of the DMBPC homopolymer increased, the MVR, MAI, and % ductility of the blend all decreased. However, the blend had a higher scratch resistance (compare the pencil hardness of Examples 3, 6, 9 with Examples 12, 15, and 18).

All of the Comparative Examples and Examples 1-18 were transparent.

The polycarbonate blends of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A polycarbonate blend comprising:
a first polycarbonate polymer comprising at least about 85% of dimethyl bisphenol cyclohexane (DMBPC) units of Formula (1): 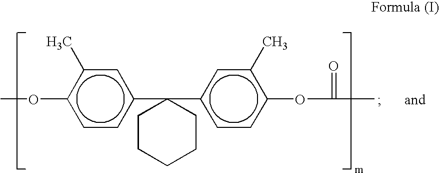
a second polycarbonate polymer which differs from the first polycarbonate polymer;
wherein a molded sample of the polycarbonate blend has a scratch rating of F or harder according to ASTM D3363-92a and an impact value of at least 50 Joules according to ISO 6603.

2. The polycarbonate blend of claim 1, wherein the first polycarbonate polymer has a melt volume flow rate of from about 4 to about 25 cm³/10 minutes.

3. The polycarbonate blend of claim 1, wherein the second polycarbonate polymer has a melt volume flow rate of from about 5 to about 30 cm³/10 minutes.

4. The polycarbonate blend of claim 1, wherein the weight ratio of the second polycarbonate polymer to first polycarbonate polymer is from about 10:90 to about 90:10.

5. The polycarbonate blend of claim 1, wherein the weight ratio of the second polycarbonate polymer to first polycarbonate polymer is from about 40:60 to about 60:40.

6. The polycarbonate blend of claim 1, wherein the second polycarbonate polymer comprises a monomer of Formula (II): 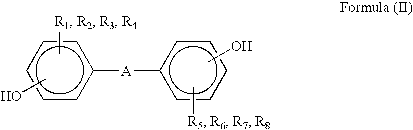
wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

7. The polycarbonate blend of claim 1, wherein the second polycarbonate polymer is of Formula (III): 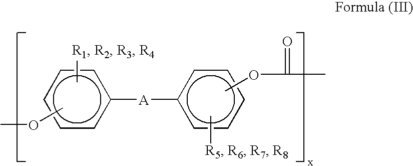
wherein R₁ through R₈ are each independently selected from hydrogen, halogen, nitro, cyano, C₁-C₂₀ alkyl, C₄-C₂₀ cycloalkyl, and C₆-C₂₀ aryl; A is selected from a bond, —O—, —S—, —SO₂—, C₁-C₁₂ alkyl, C₆-C₂₀ aromatic, and C₆-C₂₀ cycloaliphatic; and x is the degree of polymerization.

8. The polycarbonate blend of claim 1, wherein the second polycarbonate polymer is a bisphenol-A homopolymer.

9. The polycarbonate blend of claim 1, wherein the first polycarbonate polymer has a weight average molecular weight of from about 20,000 to about 30,000 g/mol.

10. The polycarbonate blend of claim 1, wherein the second polycarbonate polymer has a weight average molecular weight of from about 20,000 to about 30,000 g/mol.

11. The polycarbonate blend of claim 1, wherein the polycarbonate blend has an impact value of at least 100 Joules according to ISO 6603.

12. A polycarbonate blend comprising:
a dimethyl bisphenol cyclohexane (DMBPC) homopolymer having repeating units of Formula (1): 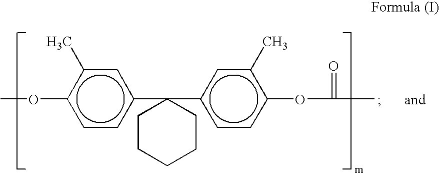
a bisphenol-A homopolymer;
wherein a molded sample of the polycarbonate blend has a scratch rating of F or harder according to ASTM D3363-92a and an impact value of at least 100 Joules according to ISO 6603.

13. The polycarbonate blend of claim 12, wherein the DMBPC homopolymer has a melt volume flow rate of from about 4 to about 25 cm³/10 minutes.

14. The polycarbonate blend of claim 12, wherein the bisphenol-A homopolymer has a melt volume flow rate of from about 5 to about 30 cm³/10 minutes.

15. The polycarbonate blend of claim 12, wherein the weight ratio of the bisphenol-A homopolymer to DMBPC homopolymer is from about 40:60 to about 60:40.

16. An article molded from a polycarbonate blend comprising:
a first polycarbonate polymer including at least about 85% of dimethyl bisphenol cyclohexane (DMBPC) units of Formula (1): 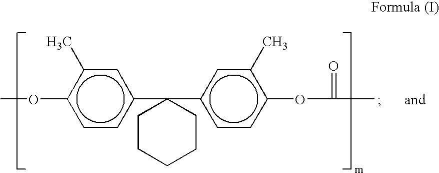
a second polycarbonate polymer which differs from the first polycarbonate polymer;
wherein a molded sample of the polycarbonate blend has a scratch rating of F or harder according to ASTM D3363-92a and an impact value of at least 50 Joules according to ISO 6603.

17. The article of claim 16, wherein the first polycarbonate polymer has a melt volume flow rate of from about 4 to about 25 cm³/10 minutes.

18. The article of claim 16, wherein the second polycarbonate polymer has a melt volume flow rate of from about 5 to about 30 cm³/10 minutes.

19. The article of claim 16, wherein the weight ratio of the second polycarbonate polymer to first polycarbonate polymer is from about 40:60 to about 60:40.

20. The article of claim 16, wherein the second polycarbonate polymer is a bisphenol-A homopolymer.

21. The article of claim 16, wherein the article is selected from the group consisting of a bezel, a keypad, a housing, and an optical display film.
